(19) United States
(12) Patent Application Publication
(10) Pub. No.: US 2024/0279869 A1
(43) Pub. Date: Aug. 22, 2024

(54) ELASTIC CONDUCTIVE FIBER AND METHOD FOR PREPARING THE SAME

(71) Applicant: Southern Taiwan University of Science and Technology, Tainan City (TW)

(72) Inventors: Ying-Nien CHOU, Kaohsiung City (TW); Lien-Chung HUNG, Tainan City (TW)

(21) Appl. No.: 18/447,507

(22) Filed: Aug. 10, 2023

(30) Foreign Application Priority Data
Feb. 21, 2023 (TW) 112106339

(51) Int. Cl. D06M 11/83; D06M 11/42; H01B 1/22

(52) U.S. Cl. CPC D06M 11/83; D06M 11/42; H01B 1/22

(57) ABSTRACT

A method for preparing an elastic conductive fiber includes: immersing an elastic fiber in a first treating composition containing a metal trifluoroacetate and an alcohol solvent, so as to obtain a processed elastic fiber containing the metal trifluoroacetate; and immersing the processed elastic fiber in a second treating composition containing water, a reducing agent and a nano conductive material, so that a metal particle is formed on a surface of the processed elastic fiber by reducing metallic ions in the metal trifluoroacetate, and the nano conductive material is deposited on a surface of the processed elastic fiber and a surface of the metal particle. An elastic conductive fiber is also disclosed.

### CROSS-REFERENCE TO RELATED APPLICATION

This application claims priority to Taiwanese Invention Patent Application No. 112106339, filed on Feb. 21, 2023.

### FIELD

The present disclosure relates to an elastic conductive fiber and a method for preparing the same.

### BACKGROUND

US 20160122941 A1 discloses a conductive yarn, a conductive yarn-based pressure sensor including the conductive yarn, and a method for producing the conductive yarn. In this patent document, the conductive yarn includes a fiber, a flexible polymer on the fiber, and metallic nanoparticles contained in the flexible polymer. The method for producing the conductive yarn includes: coating a yarn with a flexible polymer by, for example, immersing the yarn in a flexible polymer solution; soaking the flexible polymer coated on the yarn in a metallic precursor solution to allow metallic ions to be absorbed into the flexible polymer; and reducing the metallic ions to metallic nanoparticles with a reducer. By coating the flexible polymer on a surface of the yarn and forming the metallic nanoparticles in the flexible polymer, the subsequently formed conductive yarn, which has both flexibility and conductivity, can therefore be obtained without changing the properties of the yarn itself.

In spite of the aforesaid, there is still a need for those skilled in the art to develop a conductive yarn having a conductivity that meets the requirements of the industry.

### SUMMARY

Accordingly, in a first aspect, the present disclosure provides a method for preparing an elastic conductive fiber, which can alleviate at least one of the drawbacks of the prior art. The method includes:
immersing an elastic fiber in a first treating composition containing a metal trifluoroacetate and an alcohol solvent, so as to obtain a processed elastic fiber containing the metal trifluoroacetate; and
immersing the processed elastic fiber in a second treating composition containing water, a reducing agent and a nano conductive material, so that a metal particle is formed on a surface of the processed elastic fiber by reducing metallic ions in the metal trifluoroacetate, and the nano conductive material is deposited on a surface of the processed elastic fiber and a surface of the metal particle.

In a second aspect, the present disclosure provides an elastic conductive fiber, which can alleviate at least one of the drawbacks of the prior art. The elastic conductive fiber includes:
an elastic fiber;
a metal particle formed on a surface of the elastic fiber; and
a nano conductive material deposited on a surface of the elastic fiber and
a surface of the metal particle.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows the high-resolution field emission scanning electron microscope (SEM) image of the elastic conductive fiber of Example 1, infra.

FIG. 2 shows the high-resolution field SEM image of the elastic conductive fiber of Example 2, infra.

FIG. 3 shows the high-resolution field SEM image of the elastic conductive fiber of Example 3, infra.

FIG. 4 shows the high-resolution field SEM image of the elastic conductive fiber of Example 4, infra.

FIG. 5 shows the high-resolution field SEM image of the elastic conductive fiber of Example 5, infra.

FIG. 6 shows the high-resolution field SEM image of the elastic conductive fiber of Comparative Example 1, infra.

FIG. 7 shows the high-resolution field SEM image of the elastic conductive fiber of polyurethane elastic fiber, infra.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a method for preparing an elastic conductive fiber, which includes:
immersing an elastic fiber in a first treating composition containing a metal trifluoroacetate and an alcohol solvent, so as to obtain a processed elastic fiber containing the metal trifluoroacetate; and
immersing the processed elastic fiber in a second treating composition containing water, a reducing agent and a nano conductive material, so that a metal particle is formed on a surface of the processed elastic fiber by reducing metallic ions in the metal trifluoroacetate, and the nano conductive material is deposited on a surface of the processed elastic fiber and a surface of the metal particle.

An example of the elastic fiber may include, but is not limited to, a polyurethane elastic fiber.

According to the present disclosure, the metal trifluoroacetate may be of a single type or different types. Examples of the metal trifluoroacetate may include, but are not limited to, silver trifluoroacetate, copper trifluoroacetate, and gold trifluoroacetate. In certain embodiments, the metal trifluoroacetate may be selected from the group consisting of silver trifluoroacetate, copper trifluoroacetate, gold trifluoroacetate, and combinations thereof.

In certain embodiments, the metal trifluoroacetate may be present in an amount ranging from 10 wt % to 50 wt % based on 100 wt % of the first treating composition.

According to the present disclosure, the alcohol solvent may be utilized to dissolve the metal trifluoroacetate, and may be of a single type or different types. Examples of the alcohol solvent may include, but are not limited to, an alcohol having one carbon atom, an alcohol having two carbon atoms, an alcohol having three carbon atoms and an alcohol having four carbon atoms. In certain embodiments, the alcohol solvent may be selected from the group consisting of an alcohol having one carbon atom, an alcohol having two carbon atoms, an alcohol having three carbon atoms and an alcohol having four carbon atoms.

In certain embodiments, the elastic fiber is immersed in the first treating composition having a temperature ranging from 25° C. to 70° C. for a time period ranging from 5 minutes to 40 minutes.

Examples of the reducing agent of the second treating composition may include, but are not limited to, aniline, ascorbic acid and hydrazine. In certain embodiments, the reducing agent may be present in an amount ranging from 0.5 wt % to 4 wt % based on 100 wt % of the second treating composition.

In certain embodiments, the nano conductive material of the second treating composition may be selected from the group consisting of a nano metal wire, a nano metal particle, a carbon nanotube, and combinations thereof. In certain embodiments, the nano metal wire may be selected from the group consisting of a nano silver wire, a nano gold wire, a nano copper wire, and combinations thereof. In certain embodiments, the nano metal particle may be selected from the group consisting of a nano silver particle, a nano gold particle, a nano copper particle, and combinations thereof.

In certain embodiments, the nano conductive material may be present in an amount ranging from 1.56 wt % to 50 wt % based on 100 wt % of the second treating composition.

In certain embodiments, the processed elastic fiber may be immersed in the second treating composition having a temperature ranging from 25° C. to 90° C. for a time period ranging from 10 minutes to 140 minutes.

The present disclosure also provides an elastic conductive fiber, which includes:
an elastic fiber;
a metal particle formed on a surface of the elastic fiber; and
a nano conductive material deposited on a surface of the elastic fiber and a surface of the metal particle.

The disclosure will be further described by way of the following examples. However, it should be understood that the following examples are solely intended for the purpose of illustration and should not be construed as limiting the disclosure in practice.

### EXAMPLES

### Preparation of Elastic Conductive Fiber

### Example 1

First, 10 g of polyurethane elastic fiber (5 cm in length and 0.5 mm in diameter) was immersed in 3.5 g of a first treating composition at a temperature of 25° C. for 30 minutes, so that the polyurethane elastic fiber absorbed the first treating composition to form an immersed elastic fiber. The first treating composition contained silver trifluoroacetate and ethanol, and the silver trifluoroacetate was present in an amount of 35 wt % based on 100 wt % of the first treating composition. Afterward, the immersed elastic fiber was taken out from the first treating composition, and then was dried in an oven at 50° C. for 30 minutes, so as to remove the ethanol remaining in the immersed elastic fiber, thereby obtaining a processed elastic fiber containing the silver trifluoroacetate.

Next, the processed elastic fiber was immersed in 0.5 g of a second treating composition at a temperature of 25° C. for 60 minutes, thereby obtaining an elastic conductive fiber. The second treating composition contained nano silver wires (serving as a nano conductive material, and with lengths ranging from 10 μm to 20 μm and diameters ranging from 5 nm to 20 nm), ascorbic acid and 10 mL of water. In addition, the nano silver wires were present in an amount of 25 wt % based on 100 wt % of the second treating composition, and the ascorbic acid was present in an amount of 2 wt % based on 100 wt % of the second treating composition. In formation of the elastic conductive fiber, the ascorbic acid was utilized to reduce silver ions in the silver trifluoroacetate of the processed elastic fiber so that silver particles were formed on a surface of the processed elastic fiber. In the meanwhile, the nano silver wires were deposited on a surface of the processed elastic fiber and on a surface of at least one of the silver particles. The thus obtained elastic conductive fiber was then taken out from the second treating composition, followed by washing off the ascorbic acid remaining therein using 63 mL of deionized water and subsequently drying in an oven at 50° C. for 30 minutes.

### Examples 2 to 5

The procedures for preparing the elastic conductive fibers of Examples 2 to 5 were similar to those of Example 1, except that the types of the nano conductive material used for forming the second treating composition were varied as shown in Table 1 below.

### Comparative Example 1

First, 10 g of polyurethane elastic fiber (5 cm in length and 0.5 mm in diameter) was immersed in 3.5 g of a first treating composition at a temperature of 25° C. for 30 minutes, so that the polyurethane elastic fiber absorbed the first treating composition to form an immersed elastic fiber. The first treating composition contained silver trifluoroacetate and ethanol, and the silver trifluoroacetate was present in an amount of 35 wt % based on 100 wt % of the first treating composition. Afterward, the immersed elastic fiber was taken out from the first treating composition, and then was dried in an oven at 50° C. for 30 minutes, so as to remove the ethanol remaining in the immersed elastic fiber, thereby obtaining a processed elastic fiber containing the silver trifluoroacetate.

Next, the processed elastic fiber was immersed in 0.5 g of a second treating composition at a temperature of 25° C. for 60 minutes, thereby obtaining an elastic conductive fiber. The second treating composition contained ascorbic acid and 10 mL of water. In addition, the ascorbic acid was present in an amount of 2 wt % based on 100 wt % of the second treating composition. The thus obtained elastic conductive fiber was then taken out from the second treating composition, followed by washing off the ascorbic acid remaining therein using 63 mL of deionized water, and subsequently drying in an oven at 50° C. for 30 minutes.

### Comparative Example 2

First, 10 g of polyurethane elastic fiber (5 cm in length and 0.5 mm in diameter) was immersed in 4 g of a second treating composition at a temperature of 25° C. for 60 minutes, thereby obtaining an elastic conductive fiber. The second treating composition contained nano silver wires (with lengths ranging from 10 μm to 20 μm and diameters ranging from 5 nm to 20 nm) and 10 mL of water, and the nano silver wires were present in an amount of 25 wt % based on 100 wt % of the second treating composition. Next, the thus obtained elastic conductive fiber was taken out from the second treating composition, followed by drying in an oven at 50° C. for 30 minutes.

### Comparative Example 3

The procedures for preparing the elastic conductive fibers of Comparative Example 3 were similar to those of Comparative Example 2, except that carbon nanotubes were used in replacement of the nano silver wires.

### Property Evaluation

### Morphological Analysis:

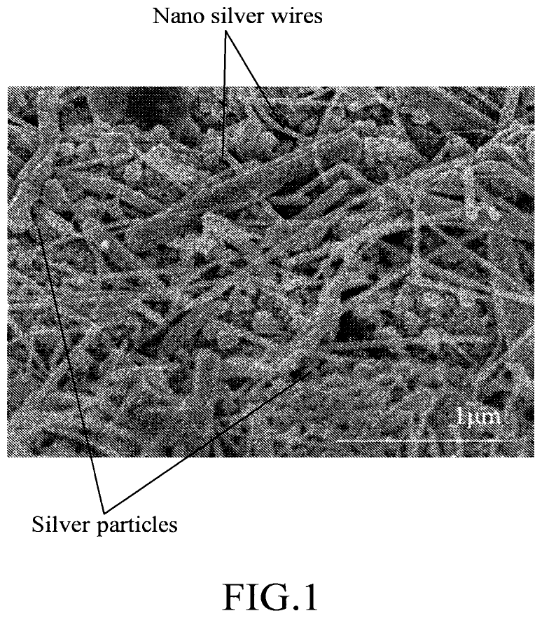

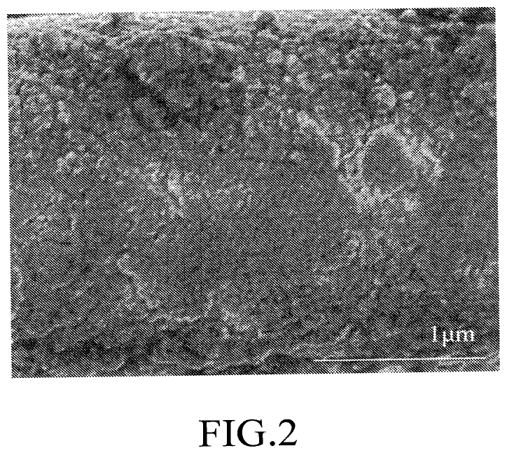

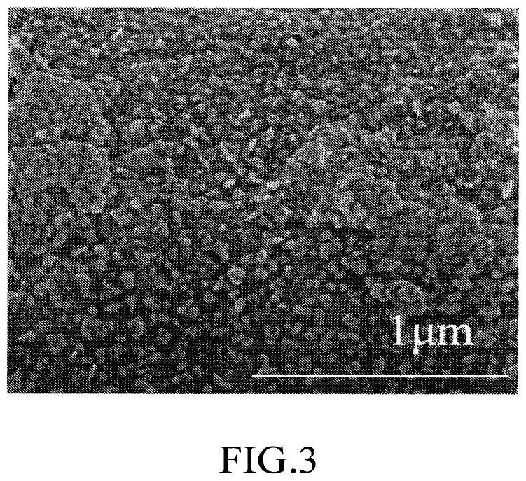

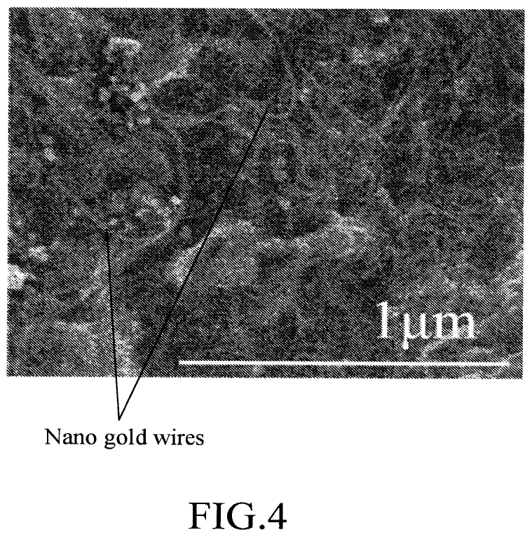

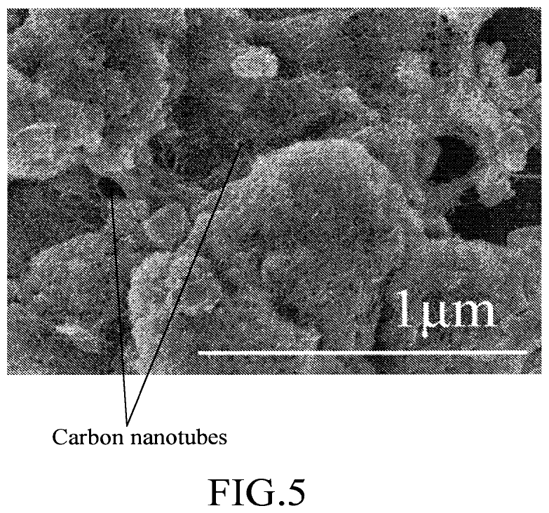

The polyurethane elastic fiber and the elastic conductive fiber of each of Examples 1 to 5 and Comparative Example 1 were subjected to morphological analysis using a high-resolution field emission scanning electron microscope (JEOL Ltd., Model: JSM-6701F). The results are shown in FIGS. 1 to 7.

### Measurement of Electrical Resistance:

A respective one of the elastic conductive fibers of Examples 1 to 5 and Comparative Example 1, and the polyurethane elastic fiber (taking 3 cm of each) was subjected to electrical resistance (A0) measurement using a resistance measuring instrument (Keithley, Model: LSR4-KHT200), and then was placed in a tensile machine (WINTEAM, Model: WTSPP-20200-A) to be stretched to a length of 3.9 cm with a predetermined tensile force. Next, the tensile force was released so that the respective one of the elastic conductive fibers and the polyurethane elastic fiber returned to its original length. Thereafter, the respective one of the elastic conductive fibers and the polyurethane elastic fiber was subjected to electrical resistance (A1) measurement using the aforesaid resistance measuring instrument. The resistance value (A0) and resistance value (A1) measured for the polyurethane elastic fiber are both 10⁷ Ω/cm, and the resistance value (A0) and resistance value (A1) measured for the respective one of the elastic conductive fibers are shown in Tables 1 and 2 below.

### Measurement of Change Rate of Electrical Resistance at Different Lengths:

A respective one of the elastic conductive fibers of Example 1 and Comparative Example 1 (each having a length of 3 cm) was subjected to electrical resistance (A0) measurement using a resistance measuring instrument (Keithley, Model: LSR4-KHT200), and then was placed in a tensile machine (WINTEAM, Model: WTSPP-20200-A) to be stretched to lengths of 3.9 cm, 4.2 cm and 4.5 cm, respectively, with different tensile forces. In the meanwhile, the resistance value at each length was measured using the resistance measuring instrument, which was electrically connected to the tensile machine, and a data processor with Keith Link software.

Afterward, the change rate of electrical resistance at each length was calculated using the following Equation (I):

$$A = [ ( B - A 0 ) / A 0 ] \times 100 \% \qquad ( I )$$

where A=change rate of electrical resistance
B=resistance value at length of 3.9 cm, 4.2 cm, or 4.5 cm
A0=resistance value at length of 3 cm before being stretched

The results are shown in Tables 1 and 2 below.

### Elemental Analysis:

The silver, oxygen, carbon and gold contents of the elastic conductive fiber of each of Examples 1 to 5 and Comparative Example 1 were measured using an energy-dispersive X-ray spectrometer (JEOL, Model: JSM-6701 F). The results are shown in Tables 1 and 2 below.

TABLE 1

| | | | Example | | | | |
|---|---|---|---|---|---|---|---|
| | | | 1 | 2 | 3 | 4 | 5 |
| Elastic fiber | Polyurethane elastic fiber (g) | | 10 | 10 | 10 | 10 | 10 |
| First treating | Silver trifluoroacetate (wt %) | | 35 | 35 | 35 | 35 | 35 |
| composition | Ethanol (mL) | | 10 | 10 | 10 | 10 | 10 |
| Conditions for | Temperature (° C.) | | 25 | 25 | 25 | 25 | 25 |
| immersion in first | Time (min) | | 30 | 30 | 30 | 30 | 30 |
| treating composition | | | | | | | |
| Second treating | Water (mL) | | 10 | 10 | 10 | 10 | 10 |
| composition | Ascorbic acid (wt %) | | 2 | 2 | 2 | 2 | 2 |
| | Nano silver wires (wt %) | | 25 | 0 | 0 | 0 | 0 |
| | (with lengths ranging from 10 | | | | | | |
| | μm to 20 μm and diameters | | | | | | |
| | ranging from 5 nm to 20 nm) | | | | | | |
| | Nano silver particles (wt %) | | 0 | 25 | 0 | 0 | 0 |
| | (with particle sizes ranging | | | | | | |
| | from 5 nm to 20 nm) | | | | | | |
| | Nano gold particles (wt %) | | 0 | 0 | 25 | 0 | 0 |
| | (with particle sizes ranging | | | | | | |
| | from 1.5 nm to 43.8 nm) | | | | | | |
| | Nano gold wires (wt %) | | 0 | 0 | 0 | 25 | 0 |
| | (with lengths of 5 μm and | | | | | | |
| | diameters ranging from 5 nm | | | | | | |
| | to 20 nm) | | | | | | |
| | Carbon nanotubes (wt %) | | 0 | 0 | 0 | 0 | 25 |
| | (with lengths ranging from 10 | | | | | | |
| | μm to 30 μm and diameters | | | | | | |
| | ranging from 5 nm to 20 nm) | | | | | | |
| Conditions for | Temperature (° C.) | | 25 | 25 | 25 | 25 | 25 |
| immersion in | Time (min) | | 60 | 60 | 60 | 60 | 60 |
| second treating | | | | | | | |
| composition | | | | | | | |
| Evaluation of | Silver content (wt %) | | 47.13 | 61.94 | 72.79 | 25.97 | 32.44 |
| elastic conductive fiber | Oxygen content (wt %) | | 26.34 | 28.10 | 19.0 | 24.32 | 26.32 |
| | Carbon content (wt %) | | 26.53 | 9.96 | 6.52 | 16.28 | 41.24 |
| | Gold content (wt %) | | 0 | 0 | 1.69 | 33.43 | 0 |
| | Resistance value | A0 | 5.40 | 10.02 | 7.25 | 2.81 | 12.41 |
| | (Ω/cm) | A1 | 5.40 | 10.02 | 7.25 | 2.81 | 12.41 |
| | Change rate of | 3.9 cm | 6.66 | — | — | — | — |
| | electrical | 4.2 cm | 27.84 | — | — | — | — |
| | resistance at | 4.5 cm | 209.79 | — | — | — | — |
| | different lengths | | | | | | |
| | (%) | | | | | | |

TABLE 2

| | | | Comparative Example | | |
|---|---|---|---|---|---|
| | | | 1 | 2 | 3 |
| Elastic fiber | Polyurethane elastic fiber (g) | | 10 | 10 | 10 |
| First treating | Silver trifluoroacetate (wt %) | | 35 | 0 | 0 |
| composition | Ethanol (mL) | | 10 | 0 | 0 |
| Conditions for | Temperature (° C.) | | 25 | — | — |
| immersion in | Time (min) | | 30 | — | — |
| first treating | | | | | |
| composition | | | | | |
| Second treating | Water (mL) | | 10 | 10 | 10 |
| composition | Ascorbic acid (wt %) | | 2 | 0 | 0 |
| | Nano silver wires (wt %) | | 0 | 25 | 0 |
| | (with lengths ranging from 10 | | | | |
| | μm to 20 μm and diameters | | | | |
| | ranging from 5 nm to 20 nm) | | | | |
| | Nano silver particles (wt %) | | 0 | 0 | 0 |
| | (with particle sizes ranging | | | | |
| | from 5 nm to 20 nm) | | | | |
| | Nano gold particles (wt %) | | 0 | 0 | 0 |
| | (with particle sizes ranging | | | | |
| | from 1.5 nm to 43.8 nm) | | | | |
| | Nano gold wires (wt %) | | 0 | 0 | 0 |
| | (with lengths of 5 μm and | | | | |
| | diameters ranging from 5 nm | | | | |
| | to 20 nm) | | | | |
| | Carbon nanotubes (wt %) | | 0 | 0 | 25 |
| | (with lengths ranging from 10 | | | | |
| | μm to 30 μm and diameters | | | | |
| | ranging from 5 nm to 20 nm) | | | | |
| Conditions for | Temperature (° C.) | | 25 | 25 | 25 |
| immersion in | Time (min) | | 60 | 60 | 60 |
| second treating | | | | | |
| composition | | | | | |
| Evaluation of | Silver content (wt %) | | 39.9 | — | — |
| elastic | Oxygen content (wt %) | | 31.5 | — | — |
| conductive | Carbon content (wt %) | | 29.53 | — | — |
| fiber | Gold content (wt %) | | 0 | — | — |
| | Resistance value | A0 | 20.08 | — | — |
| | (Ω/cm) | A1 | 20.12 | — | — |
| | Change rate of | 3.9 cm | 8.02 | — | — |
| | electrical | 4.2 cm | 32.18 | — | — |
| | resistance at | 4.5 cm | 208.50 | — | — |
| | different lengths | | | | |
| | (%) | | | | |

### Results:

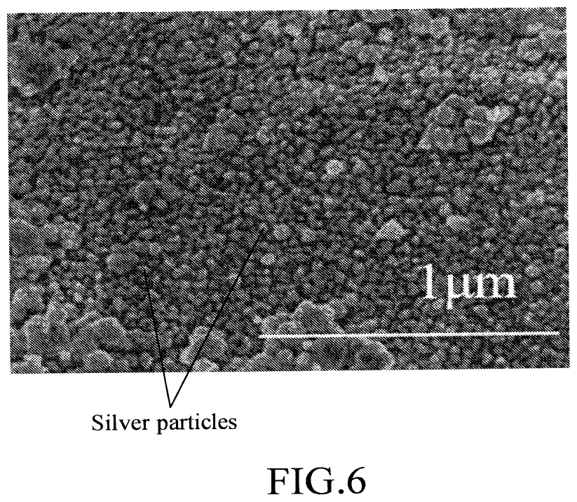

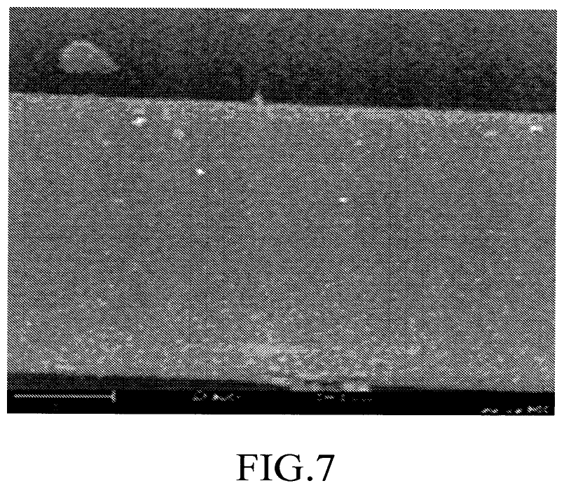

Referring to FIGS. 1 to 5, by virtue of immersing the polyurethane elastic fiber in the first treating composition and the second treating composition in sequence, the silver particles were formed and the nano conductive material (such as nano silver wires, nano silver particles, nano gold particles, nano gold wires, and carbon nanotubes) was deposited on a surface of the processed elastic fiber of each of Examples 1 to 5. Referring to FIG. 6, by virtue of immersing the polyurethane elastic fiber in the first treating composition and the second treating composition in sequence, the silver particles were formed on a surface of the processed elastic fiber of Comparative Example 1. In addition, referring to FIG. 7, the morphological appearance of the polyurethane elastic fiber was also observed.

Furthermore, based on the results of the elemental analysis as shown in Table 1, the elastic conductive fiber obtained through the method according to the present disclosure contains silver, carbon or gold, indicating that the method for preparing the elastic conductive fiber according to the present disclosure can indeed produce the elastic conductive fiber containing the silver particles and the nano conductive material.

Referring to Tables 1 and 2, a respective one of the elastic conductive fibers of Examples 1 to 5 had a resistance value ranging from 2.81 Ω/cm to 12.41 Ω/cm due to presence of the silver particles, which were formed on the surface of the processed elastic fiber by reducing silver ions in the silver trifluoroacetate and the nano conductive material, which was deposited on the surface of the processed elastic fiber and a surface of at least one of the silver particles. In contrast, the elastic conductive fiber of Comparative Example 1 had a resistance value of 20.08 Ω/cm due to lack of a nano conductive material in the second treating composition. These results indicate that the method for preparing the elastic conductive fiber according to the present disclosure can produce the elastic conductive fiber having high conductivity.

Moreover, as shown in Table 1, the elastic conductive fiber of Example 1 had resistance values varying with lengths thereof. These results indicate that the elastic conductive fiber obtained through the method according to the present disclosure can serve as a strain-sensing fiber, e.g., a resistance strain-sensing fiber, and hence can be applied in a strain sensor of a wearable electronic device. Such stain sensor has various advantages, such as a low initial resistance, a broad strain-sensing range, and a good quality of electrical resilience under repeated stretching. Furthermore, after the tensile force was released, a respective one of the elastic conductive fibers of Examples 1 to 5 had a resistance value that was the same with that of the elastic conductive fiber not being stretched. These results indicate that the elastic conductive fiber according to the present disclosure is reusable, and therefore has a long service life.

In sum, through the formation of a metal particle and the deposition of a nano conductive material, the method for preparing the elastic conductive fiber according to the present disclosure can fabricate the elastic conductive fiber having good electrical conductivity.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for preparing an elastic conductive fiber, comprising:
immersing an elastic fiber in a first treating composition containing a metal trifluoroacetate and an alcohol solvent, so as to obtain a processed elastic fiber containing the metal trifluoroacetate; and
immersing the processed elastic fiber in a second treating composition containing water, a reducing agent and a nano conductive material, so that a metal particle is formed on a surface of the processed elastic fiber by reducing metallic ions in the metal trifluoroacetate, and the nano conductive material is deposited on a surface of the processed elastic fiber and a surface of the metal particle.

2. The method as claimed in claim 1, wherein the metal trifluoroacetate is present in an amount ranging from 10 wt % to 50 wt % based on 100 wt % of the first treating composition.

3. The method as claimed in claim 1, wherein the elastic fiber is immersed in the first treating composition at a temperature ranging from 25° C. to 70° C. for a time period ranging from 5 minutes to 40 minutes.

4. The method as claimed in claim 1, wherein the reducing agent is present in an amount ranging from 0.5 wt % to 4 wt % based on 100 wt % of the second treating composition.

5. The method as claimed in claim 1, wherein the nano conductive material is present in an amount ranging from 1.56 wt % to 50 wt % based on 100 wt % of the second treating composition.

6. The method as claimed in claim 1, wherein the nano conductive material is selected from the group consisting of a nano metal wire, a nano metal particle, a carbon nanotube, and combinations thereof.

7. The method as claimed in claim 1, wherein the processed elastic fiber is immersed in the second treating composition at a temperature ranging from 25° C. to 90° C. for a time period ranging from 10 minutes to 140 minutes.

8. The method as claimed in claim 6, wherein the nano metal wire is selected from the group consisting of a nano silver wire, a nano gold wire, a nano copper wire, and combinations thereof.

9. An elastic conductive fiber, comprising:
an elastic fiber;
a metal particle formed on a surface of the elastic fiber; and
a nano conductive material deposited on a surface of the elastic fiber and a surface of the metal particle.
